(19) United States
(12) Patent Application Publication
(10) Pub. No.: US 2025/0121608 A1
(43) Pub. Date: Apr. 17, 2025

(54) IMAGE FORMING APPARATUS, IMAGE FORMING METHOD, AND RECORDING MEDIUM

(71) Applicant: Konica Minolta, Inc., Tokyo (JP)

(72) Inventor: Hideyuki TORIYAMA, Tokyo (JP)

(21) Appl. No.: 18/907,962

(22) Filed: Oct. 7, 2024

(30) Foreign Application Priority Data
Oct. 13, 2023 (JP) 2023-177355

(51) Int. Cl. B41J 2/21

(52) U.S. Cl. CPC B41J 2/2139; B41J 2/2142; B41J 2/2146

(57) ABSTRACT

An image forming apparatus includes: an image former that causes a head unit having a plurality of nozzles arranged in a row to eject a color material onto a recording medium conveyed in a conveyance direction to generate dots; a mover that relatively moves the recording medium and the head unit in a direction intersecting an arrangement direction of the plurality of nozzles in the head unit; a detector that detects a first adhesion amount of a color material in a first peripheral region around a nozzle-missing region corresponding to a malfunctioning nozzle; a region setter that sets an allocation region having an area corresponding to the first adhesion amount; and an allocator that allocates dot data corresponding to a malfunctioning nozzle to a normal nozzle in the allocation region.

### CROSS REFERENCE TO RELATED APPLICATIONS

The present invention claims priority under 35 U.S.C. § 119 to Japanese Application No. 2023-177355, filed on Oct. 13, 2023, the entire contents of which being incorporated herein by reference.

### BACKGROUND OF THE INVENTION

### Technical Field

The present invention relates to an image forming apparatus, an image forming method, and a recording medium.

### Description of Related Art

There has conventionally been an image forming apparatus that forms an image by operating recording elements that each include a plurality of nozzles and a drive element such as a piezoelectric element that causes pressure fluctuations in ink inside the nozzles to generate a plurality of dots. In such an image forming apparatus, with a demand for higher resolution and higher accuracy of an image and an accompanying increase in the number of recording elements, the number of malfunctioning recording elements that do not operate normally has increased, making image quality more likely to deteriorate.

To cope with such a problem, there is a technique of suppressing printing failure by operating other recording elements as substitutes for the malfunctioning recording elements to complement the image. For example, JP 2023-072440A discloses an image forming apparatus that suppresses printing failure by allocating extra data corresponding to the amount of adhesion in the vicinity of the dot generation position of a malfunctioning recording element and allocation data corresponding to dot data corresponding to the malfunctioning recording element. Furthermore, for example, JP 2016-141102A discloses an image forming apparatus that calculates the density of a peripheral region of a malfunctioning recording element and allocates allocation data corresponding to one having a higher density of the left and right sides, thereby suppressing deterioration in image quality.

However, in the invention of JP 2023-072440A, the allocation data corresponding to the dot data corresponding to the malfunctioning recording element is allocated to a position separated from other dot data, and thus the invention may be unable to appropriately correct the deterioration in image quality. Furthermore, in the invention of JP 2016-141102A, in order to accurately calculate the density and allocate the allocation data, it is necessary to secure a wide peripheral region. As a result, in the same manner as in the invention of JP 2023-072440A, the allocation data is allocated to a position separated from the other dot data, and thus this invention too may be unable to appropriately correct the deterioration in image quality.

### SUMMARY OF THE INVENTION

The present invention has been made in view of such circumstances. It is an object of the present invention to provide an image forming apparatus, an image forming method, and a recording medium that can appropriately correct deterioration in image quality due to occurrence of a malfunctioning recording element.

In order to solve the above-described problem, an image forming apparatus includes:
an image former that causes a head unit having a plurality of nozzles arranged in a row to eject a color material onto a recording medium conveyed in a conveyance direction to generate dots,
a mover that relatively moves the recording medium and the head unit in a direction intersecting an arrangement direction of the plurality of nozzles in the head unit,
a detector that detects a first adhesion amount of a color material in a first peripheral region around a nozzle-missing region corresponding to a malfunctioning nozzle,
a region setter that sets an allocation region having an area corresponding to the first adhesion amount; and
an allocator that allocates dot data corresponding to a malfunctioning nozzle to a normal nozzle in the allocation region.

A method of forming an image with an image forming apparatus that includes an image former that causes a head unit having a plurality of nozzles arranged in a row to eject a color material onto a recording medium conveyed in a conveyance direction to generate dots, and
a mover that relatively moves the recording medium and the head unit in a direction intersecting an arrangement direction of the plurality of nozzles in the head unit, includes:
detecting a first adhesion amount of a color material in a first peripheral region around a nozzle-missing region corresponding to a malfunctioning nozzle,
region setting an allocation region having an area corresponding to the first adhesion amount; and
allocating dot data corresponding to the malfunctioning nozzle to a normal nozzle in the allocation region.

A non-transitory computer readable storage medium storing a program cause
a computer of an image forming apparatus including an image former that causes a head unit having a plurality of nozzles arranged in a row to eject a color material onto the recording medium conveyed in a conveyance direction to generate dots, and
a mover that relatively moves the recording medium and the head unit in a direction intersecting an arrangement direction of the plurality of nozzles in the head unit, to function as
a detector that detects a first adhesion amount of a color material in a first peripheral region around a nozzle-missing region corresponding to a malfunctioning nozzle,
a region setter that sets an allocation region having an area corresponding to the first adhesion amount, and
an allocator that allocates dot data corresponding to a malfunctioning nozzle to a normal nozzle in the allocation region.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a schematic side view illustrating an overall configuration of an image forming apparatus,

FIG. 2 is a bottom view illustrating an ink ejection face of a head unit,

FIG. 3 is a block diagram illustrating a functional configuration of the image forming apparatus,

FIG. 4 is a flowchart illustrating the flow of an ejection data generation process,

FIG. 5 is a flowchart of a missing complementation process according to a first embodiment,

FIG. 6 is a schematic diagram showing a result of a halftone process in a first peripheral region,

FIG. 7 is a diagram illustrating an example of a table of allocation regions corresponding to a first adhesion amount of ink,

FIG. 8 is a schematic diagram illustrating the first peripheral region after allocation of dot data of a malfunctioning nozzle,

FIG. 9 is a flowchart of a missing complementation process according to a second embodiment,

FIG. 10 is a diagram illustrating an example of a table of a second peripheral region corresponding to the first adhesion amount of ink,

FIG. 11 is a schematic diagram illustrating two second peripheral regions,

FIG. 12 is a schematic diagram illustrating a first peripheral region in which extra data is temporarily arranged,

FIG. 13 is a diagram illustrating an example of a table of the extra amount corresponding to the adhesion ratio of the second peripheral region; and

FIG. 14 is a schematic diagram of the first peripheral region after allocation of dot data and extra data of a malfunctioning nozzle.

### DETAILED DESCRIPTION

Hereinafter, one or more embodiments of the present invention will be described with reference to the drawings. However, the scope of the invention is not limited to the disclosed embodiments.

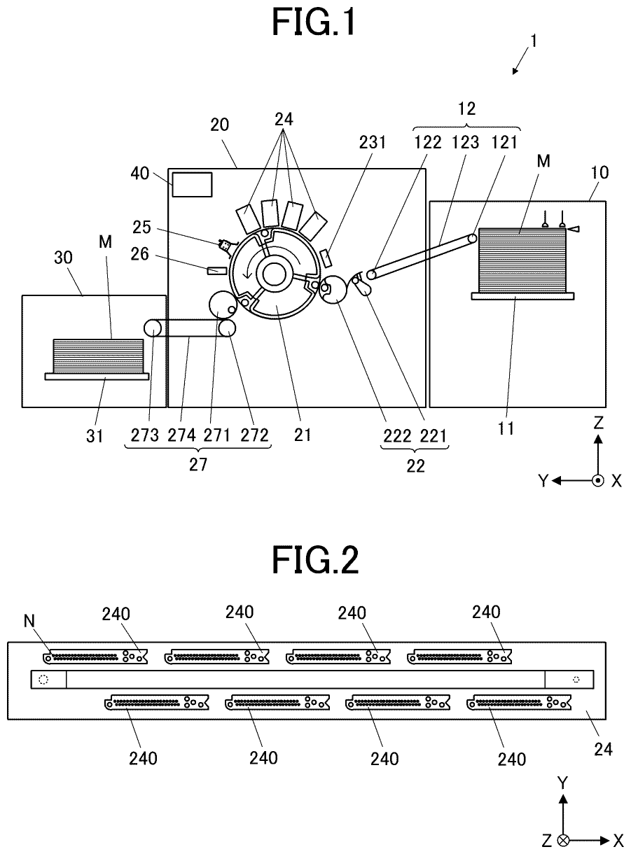

Hereinafter, embodiments of the present invention will be described with reference to the drawings. FIG. 1 is a schematic diagram illustrating an overall configuration of an inkjet recording apparatus 1 which is an embodiment of an image forming apparatus of the present invention. FIG. 1 is a side view of the inkjet recording apparatus 1.

### [Apparatus Configuration of Inkjet Recording Apparatus]

The inkjet recording apparatus 1 is a printer capable of recording a color image by ejecting inks of a plurality of colors at appropriate timings from nozzles N (see FIG. 2) while moving a recording medium M.

The inkjet recording apparatus 1 includes a medium feeder 10, an image former 20, a medium ejector 30, a controller 40 (hardware processor), and the like. The inkjet recording apparatus 1 conveys the recording medium M stored in the medium feeder 10 to the image former 20 along a predetermined conveyance path under the control of the controller 40. Then, the inkjet recording apparatus 1 ejects the recording medium M printed by the image former 20 to the medium ejector 30 under the control of the controller 40.

Note that hereinafter, an X direction, a Y direction, and a Z direction refer to the directions illustrated in FIG. 1. Furthermore, in the description below, the X direction, the Y direction, and the Z direction are referred to as a width direction, a conveyance direction, and a height direction, respectively.

### (Medium Feeder)

The medium feeder 10 sends the recording media M stored therein to the image former 20 one by one. An example of the recording medium M includes one that may be curvedly carried on the outer circumferential surface of the image forming drum 21. The recording medium M may be, for example, not only printing sheets having various thicknesses, but also cells, films, or fabrics. The medium feeder 10 includes a feed tray 11 and a feeder board 12.

### {Feed Tray}

The feed tray 11 stores the recording medium M. The feed tray 11 is a plate-like member on which one or a plurality of recording media M can be placed. The feed tray 11 is provided so as to move up and down depending on the amount of the recording media M placed thereon. The feed tray 11 is held at a position where the uppermost recording medium M is conveyed by the feeder board 12 in the up-down direction.

### {Feeder Board}

The feeder board 12 conveys the recording medium M from the feed tray 11 to the image former 20. The feeder board 12 delivers the uppermost recording medium M placed on the feed tray 11 onto a belt 123. The feeder board 12 drives the ring-shaped belt 123 whose inner side is carried by a plurality of (e.g., two) rollers 121 and 122 to convey the recording medium M on the belt 123 along the belt.

### (Image Former)

The image former 20 includes the image forming drum 21, a transfer unit 22, a drum heater 231, head units 24 (ejection operation units), an irradiator 25, an imager 26, a deliverer 27, and the like.

### {Image Forming Drum}

The image forming drum 21 has a cylindrical outer shape. The image forming drum 21 carries at most three recording media M on the outer circumferential surface of the cylindrical portion, and performs a conveyance operation of conveying the recording media M according to a rotation operation with respect to the central axis of the cylinder. By the above-described operation, the image forming drum 21 functions as a mover that relatively moves the recording medium M and the head units 24 in a direction intersecting the arrangement direction of the plurality of nozzles N (see FIG. 2) in the head units 24.

### {Transfer Unit}

The transfer unit 22 transfers the recording medium M transferred from the medium feeder 10 to the image forming drum 21. The transfer unit 22 includes a swing arm 221, a transfer drum 222, and the like.

The swing arm 221 carries one end of the recording medium M conveyed by the feeder board 12. The transfer drum 222 transfers the recording medium M carried on the swing arm 221 to the image forming drum 21. The transfer unit 22 guides the recording medium M on the feeder board 12 in a direction along the outer circumferential surface of the image forming drum 21 in this manner and transfers the recording medium M to the image forming drum 21.

### {Drum Heater}

The drum heater 231 is positioned in the vicinity of the outer circumferential surface of the image forming drum 21 and heats the outer circumferential surface of the image forming drum 21 and the recording medium M. The drum heater 231 is provided between a transfer position of the recording medium M by the transfer unit 22 and an image forming position by the head units 24 in the rotation direction of the image forming drum 21.

The drum heater 231 heats the outer circumferential surface of the image forming drum 21, thereby heating the recording medium M carried on the image forming drum 21 to an appropriate temperature. Accordingly, the curing rate of the ink that lands on the recording medium M is appropriately maintained, so that a high-quality image is stably recorded. An infrared heater, for example, is used as the drum heater 231.

### {Head Unit}

The head unit 24 ejects ink droplets toward an image forming surface of the recording medium M at appropriate timings from a plurality of nozzle openings provided in a nozzle opening surface facing the image forming surface so that the ink droplets land on the image forming surface, thereby recording an image.

In the inkjet recording apparatus 1 of the present embodiment, four head units 24 are arranged at predetermined intervals in the conveyance direction of the recording medium M so as to correspond to four respective colors of inks. The four head units 24 eject inks of C (cyan), M (magenta), Y (yellow), and K (black).

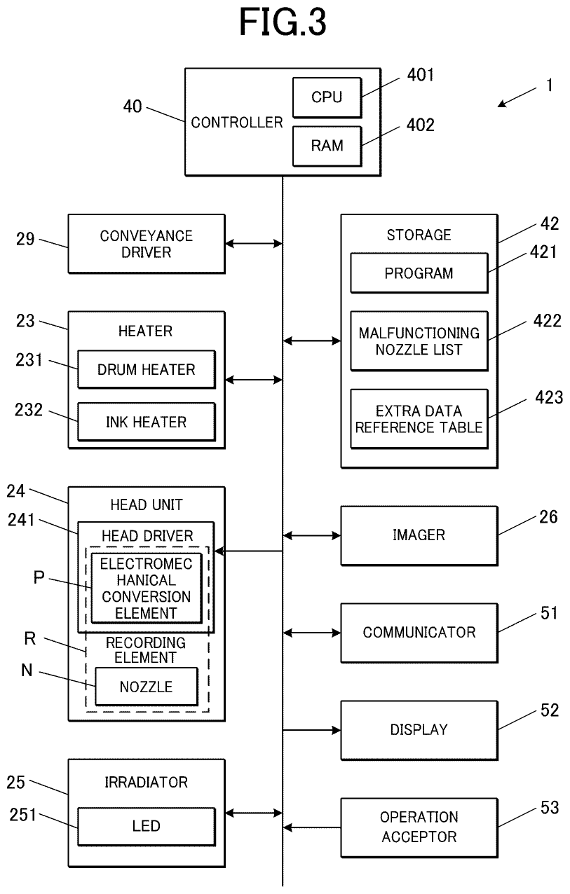

The ink ejected by the head units 24 may be, for example, phase-changed between a sol state and a gel state depending on the temperature and may be cured by being irradiated with ultraviolet rays. This type of ink is often in a gel state at room temperature and is heated to a sol state. Therefore, the ink is heated and maintained at an appropriate temperature inside and/or outside of the head unit 24 by the ink heater 232 (see FIG. 3) to be brought into a sol state.

FIG. 2 is a bottom view of the ink ejection face of the head unit 24. Each of the head units 24 includes, for example, a plurality of recording heads 240 arranged in the width direction. On a bottom surface of each recording head 240, openings of a plurality of nozzles N are arranged at equal intervals in the width direction. The bottom surface of the head unit 24 has a continuous arrangement range of the openings of the nozzles N in the recording heads 240 and extends over an image forming width of the recording medium M as a whole. That is, the positions of the openings of the nozzles N may be distributed in a plurality of places in the conveyance direction as long as the openings are arranged at appropriate intervals in the width direction.

With the above-described configuration, the head unit 24 can form an image in a single-pass manner by ejecting ink onto the recording medium M from the nozzle openings to generate dots while moving (relatively moving) the recording medium M in the conveyance direction. That is, the head unit 24 is of a line head type.

### {Irradiator}

Referring to FIG. 1, the irradiator 25 emits energy rays having a predetermined wavelength (electromagnetic waves), which are, for example, ultraviolet rays in the near ultraviolet region having a wavelength of about 400 nm. The irradiator 25 cures and fixes the ink ejected from the head units 24 that has landed on the recording medium M.

The irradiator 25 includes, for example, a light emitting diode (LED 251 (see FIG. 3)) that emits ultraviolet rays. The irradiator 25 emits ultraviolet rays by applying a voltage to the LED 251 to cause a current to flow to emit light. The irradiator 25 is located such that a position on the downstream side of the head units 24 and on the upstream side of the deliverer 27 is an ink fixing position, that is, a position where the recording medium M is irradiated with ultraviolet rays.

Note that the configuration is not limited to a configuration in which the irradiator 25 includes the LED 251 and the ultraviolet rays are emitted by the LED 251. The irradiator 25 may include, for example, a mercury lamp. In addition, in a case where the ink has a property of being cured by receiving energy rays other than ultraviolet rays, various light sources which emit energy rays having a wavelength for curing the ink are provided in the irradiator 25.

### {Imager}

The imager 26 (see FIG. 3) captures an image of the surface of the recording medium M on which the ink has been fixed by the irradiator 25. The imager 26 includes a line sensor having, for example, a CCD sensor or a CMOS sensor. The imager 26 can capture an image of a desired position on the recording medium M by capturing the recording medium M one dimensionally in the width direction at appropriate timing. The imager 26 can capture an image in, for example, each wavelength band of RGB. The controller 40 can select image data in any of the wavelength bands as necessary or combine these pieces of image data to use them for inspection processing or the like.

### {Deliverer}

The deliverer 27 conveys the recording medium M to the medium ejector 30 after the image forming operation is finished and the landed ink is cured. The deliverer 27 includes a cylindrical transfer roller 271, a plurality of (e.g., two) rollers 272 and 273, and a belt 274. The belt 274 has a loop shape and is supported on the rollers 272 and 273 at its inner surface.

The transfer roller 271 receives the recording medium M from the image forming drum 21 and guides the recording medium M onto the belt 274. The deliverer 27 conveys the recording medium M, which has been transferred from the transfer roller 271 onto the belt 274 which moves around with the rotation of the rollers 272 and 273. Under the control, the deliverer 27 feeds the recording medium M from the image forming drum 21 to the medium ejector 30.

### (Medium Ejector)

The medium ejector 30 stores the recording medium M fed from the image former 20 by the deliverer 27 until the recording medium M is taken out by a user. The medium ejector 30 includes a plate-like ejection tray 31, and the recording medium M on which an image has been formed is placed on the ejection tray 31.

### (Controller)

The controller 40 includes a central processing unit (CPU) 401, a random access memory (RAM) 402 (see FIG. 3), and the like. The CPU 401 is a processor that performs various arithmetic processes. The RAM 402 provides the CPU 401 with a working memory space and stores temporary data.

The controller 40 controls operations of the medium feeder 10, the image former 20, and the medium ejector 30, and causes an image to be formed on the recording medium M according to the data of an image to be formed by an image formation command (job) and settings related to an image forming operation. In particular, the controller 40 controls the image former 20 (the image forming drum 21 in the present embodiment) to thereby cause it to function as a mover. The mover relatively moves the recording medium M and the head units 24 in a direction intersecting an arrangement direction of the plurality of nozzles N in the head units 24.

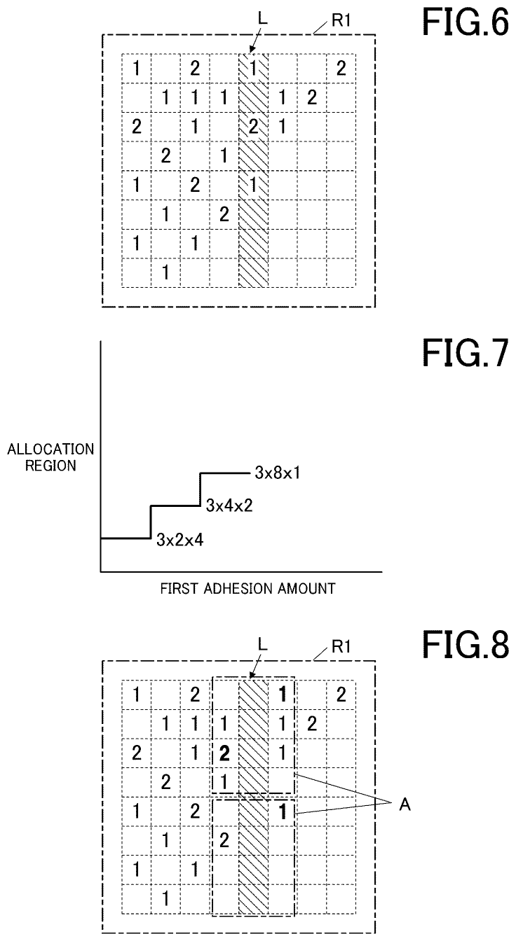

In addition, as described later, the controller 40 functions as a detector that detects a first adhesion amount and a second adhesion amount of the color materials (inks) in a first peripheral region R1 (see FIG. 6) and a second peripheral region R2 (see FIG. 12) in the periphery of a malfunctioning nozzle. Furthermore, the controller 40 functions as a generator that generates extra data corresponding to the second adhesion amount. In addition, the controller 40 functions as a region setter that sets allocation regions A (see FIG. 8) to which dot data or extra data corresponding to the malfunctioning nozzle is allocated to an area corresponding to the first adhesion amount. Furthermore, the controller 40 functions as an allocator that allocates dot data or extra data corresponding to the malfunctioning nozzle to the normal nozzles in the allocation regions A.

### [Functional Configuration of Image Forming Apparatus]

FIG. 3 is a block diagram illustrating a functional configuration of the inkjet recording apparatus 1. The inkjet recording apparatus 1 further includes a heater 23, a conveyance driver 29, a storage 42, a communicator 51, a display 52, an operation acceptor 53, and the like in addition to the head units 24, the irradiator 25, the imager 26, and the controller 40.

### {Storage}

The storage 42 includes a non-volatile memory such as a flash memory, and the like, and stores various types of setting data, a program 421, and the like. The program 421 includes a processing program related to a missing complementation process which will be described later. The setting data includes a malfunctioning nozzle list 422, an extra data reference table 423, and the like.

### {Conveyance Driver}

The conveyance driver 29 operates each unit that performs a conveyance operation of the recording medium M, such as the image forming drum 21. The conveyance driver 29 outputs a drive signal to each unit related to the conveyance operation on the basis of a control signal output from the controller 40.

### {Heater}

The heater 23 includes an ink heater 232 and the like in addition to the drum heater 231 described above. The ink heater 232 heats and maintains ink, which is fed from an ink feeder (such as an ink tank) (not illustrated) and is stored or flows in the head unit 24, to a predetermined set temperature range to keep the ink in a sol state with appropriate viscosity. The temperature of the ink and the temperature of the outer circumferential surface of the image forming drum 21 are measured by a temperature measurement unit (not illustrated), for example, a thermistor. The controller 40 controls whether or not to operate the drum heater 231 and the ink heater 232 on the basis of the measurement results. In the operation control, ON and OFF may be simply switched according to the measurement value. Alternatively, a control process based on a known technique such as proportional-integral-differential controller (PID) control may be performed.

### {Head Unit}

Each of the head units 24 includes a head driver 241, the nozzles N, and the like. The head driver 241 includes electromechanical conversion elements P, and outputs an electric signal that causes the electromechanical conversion elements P to be deformed in a predetermined deformation mode (direction and magnitude). The electromechanical conversion elements P are provided corresponding to the respective nozzles N and are deformed according to the electric signal to thereby cause the ink supply paths (in particular, pressure chambers) communicating with the nozzles N. The electromechanical conversion element P is, for example, a piezoelectric element. A set of an electromechanical conversion element P and a nozzle N forms a recording element R according to the present embodiment.

The waveform of the electric signal (voltage) that the head driver 241 outputs to the electromechanical conversion elements P is not limited to a particular waveform here. That is, the waveform may be a rectangular wave or a trapezoidal wave. The output timing is synchronized with, for example, an output cycle of a predetermined clock signal. In each output cycle, whether or not to output a signal of a waveform for ejecting each ink to the electromechanical conversion element P is switched according to data indicating the presence or absence of ejection of each nozzle, the data being generated on the basis of image data to be formed.

### {Irradiator}

The irradiator 25 has the LED 251 as described above. The irradiator 25 selectively turns on the LED 251 while an area of the recording medium M on which ink has landed is passing through the irradiation range.

### {Conveyance Driver}

The conveyance driver 29 includes a rotary motor. The conveyance driver 29 causes a configuration related to the conveyance movement of the recording medium M such as the image forming drum 21 and a roller to perform a rotation operation in synchronization at a rotation speed corresponding to an appropriate conveyance speed of the recording medium M.

### {Communicator}

The communicator 51 controls exchange of a signal with the outside of the inkjet recording apparatus 1. The communicator 51 includes, for example, a network card, and transmits and receives a signal to and from the outside in accordance with a predetermined communication standard. The predetermined communication standard includes, for example, TCP/IP. In addition, the communicator 51 may include a predetermined connection terminal, for example, any one of various terminals for USB connection, and may be capable of directly transmitting and receiving data to and from a peripheral device via a USB cable or the like.

### {Display}

The display 52 performs various kinds of display on the basis of the control of the controller 40. The display 52 includes, for example, a liquid crystal screen, and can appropriately display a menu, a status, and the like of an image forming operation. The liquid crystal display screen may be overlaid on a touch screen, and the controller 40 may detect operation contents by associating the display contents on the liquid crystal display screen with the detection position of the touch operation. The display screen is not limited to a liquid crystal display and may be an organic electro-luminescent (EL) screen or the like. Furthermore, the display 52 may include an LED lamp or the like. The LED lamp may be used for an operation of issuing notification about, for example, a power supply state, a data transmission and reception state, and/or occurrence of an operation abnormality.

### {Operation Acceptor}

The operation acceptor 53 accepts an input operation from the outside such as a user and outputs the input operation as an input signal to the controller 40. The operation acceptor 53 includes, for example, a touch screen and outputs information on a detection position during detection of a touch operation or the like. Furthermore, the operation acceptor 53 may include a key operation acceptor such as a numeric keypad, a push-button switch, and the like.

Of the above-described components, at least the controller 40 is included in the processing apparatus of the present embodiment, and the storage 42, the operation acceptor 53, and the like can be further included in the processing apparatus.

### [Ejection Data Generation Process]

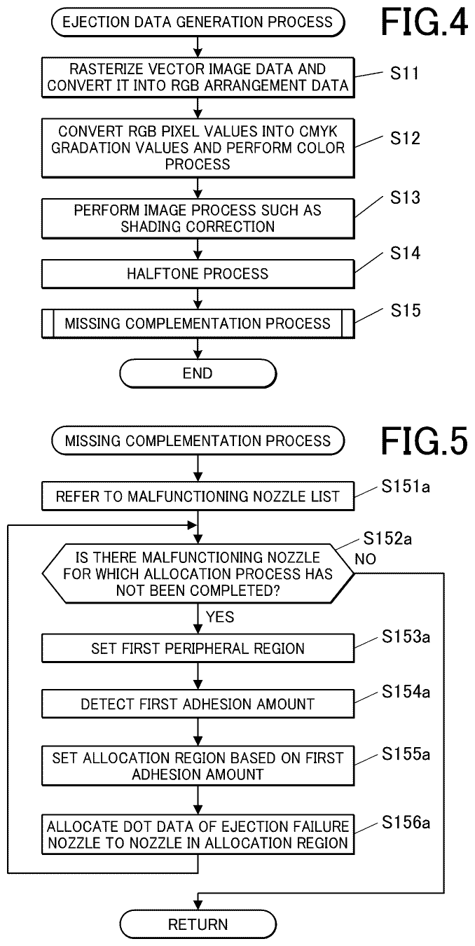

Next, an ejection data generation process according to an image forming operation setting method in the inkjet recording apparatus 1 of the present embodiment will be described. FIG. 4 is a flowchart illustrating a schematic flow of the ejection data generation process.

Note that a part or all of these processes may be performed by a dedicated circuit, or all of them may be performed by software in the CPU 401.

The ejection data is generated on the basis of image data to be output. The image data is, for example, image data in which a graphic (including a character shape and a design) or the like is expressed as a vector. First, the image data is rasterized by the controller 40 and is converted into arrangement data (raster image data) of RGB values for each pixel (step S11). The controller 40 further converts (color-converts) the arrangement data into data in which ink colors, that is, CMYK gradation values are set (step S12). The controller 40 performs adjustment, such as shading correction and limitation on the total amount of ink to be ejected, on the image data (the image data of each color of CMYK and the gradation data of each pixel) (step S13).

Thereafter, the controller 40 performs a halftone process on the adjusted image data (step S14), and converts it into a two value dot expression corresponding to the presence or absence of ink ejection at each conveyance position of each nozzle N (i.e., the presence of ink ejection represents the distribution of dot generation positions) (position determination step, position determiner). In a case where the amount of ink ejected from the nozzle N can be switched in a plurality of stages, the controller 40 may represent each position by a value of the number of steps (three steps in a case of two stages of large and small liquid droplets) according to the number of stages. Thus, initial data of the ejection data is generated.

The nozzles N corresponding to the ejection data determined as described above may include a malfunctioning nozzle (malfunctioning recording element) in which malfunctioning related to the ink ejection operation occurs. When ink is ejected from the nozzles N including the malfunctioning nozzle by using the initial ejection data as it is, ink ejection from the malfunctioning nozzle is not normally performed, and abnormality occurs in the ink ejection amount and position of a corresponding portion. In particular, in the case of malfunctioning in which the amount of ink ejected is very small or the ink is not ejected at all, a region (white streaks) where the ink has not continuously landed is generated along the position in the width direction corresponding to the nozzles N, and the image quality of the output image is significantly deteriorated. In order to reduce such deterioration in image quality, the controller 40 performs a missing complementation process in which the ink set to be ejected by the malfunctioning nozzle is replaced by the surrounding nozzles N (step S15).

### [Missing Complementation Process] (First Embodiment)

The missing complementation process by the controller 40 will be described in detail with reference to FIGS. 5 to 8. FIG. 5 is a flowchart of the missing complementation process according to the first embodiment.

First, the controller 40 refers to the malfunctioning nozzle list 422 in which malfunctioning nozzles are recorded (step S151a). Next, the controller 40 determines the presence or absence of a malfunctioning nozzle for which an allocation process described later has not been completed (step S152a). If there is no malfunctioning nozzle for which the allocation process has not been completed (step S152a; No), that is, if the allocation process has been completed for all the malfunctioning nozzles or if there is no malfunctioning nozzle, the controller 40 ends the missing complementation process and the ejection data generation process. Then, the head driver 241 outputs a drive signal to each electromechanical conversion element P on the basis of the generated and adjusted ejection data, and controls ink ejection from the corresponding nozzle N.

If there is a malfunctioning nozzle for which the allocation process has not been completed (step S152a; Yes), the controller 40 sets a first peripheral region R1 in which the pixel corresponding to one malfunctioning nozzle for which the allocation process has not been completed is substantially centered in the width direction (step S153a). After setting the first peripheral region R1, the controller 40 detects the first adhesion amount of the ink in the first peripheral region R1 (step S154a).

FIG. 6 illustrates the first peripheral region R1. In FIG. 6, the horizontal direction corresponds to the width direction, and the vertical direction corresponds to the conveyance direction. That is, the vertical direction indicates the presence or absence of ink ejection by each nozzle N for each predetermined conveyance amount. Note that in FIG. 6, 8×8 pixels in which a nozzle-missing region L that is a region along the conveyance direction with respect to the malfunctioning nozzles are defined as the first peripheral region R1 is substantially centered in the width direction, but the present invention is not limited thereto.

In FIG. 6, the dot generation amount is ternarized. That is, regarding each numerical value in each pixel in FIG. 6, 2 indicates a large droplet, 1 indicates a small droplet, and a blank portion (0) indicates non-ejection. The controller 40 detects the first adhesion amount of the ink on the basis of, for example, the sum of the dot generation amounts after the ternarization process in the first peripheral region R1. In FIG. 6, the first adhesion amount is 31. Note that the method of detecting the first adhesion amount is not limited thereto. For example, binarization may be performed, that is, the first adhesion amount may be detected on the basis of only the number of dots to which droplets are ejected without distinguishing between large droplets and small droplets.

The ink is not normally ejected continuously to the nozzle-missing region L. Therefore, the controller 40 generates dots, which are set to be generated in the nozzle-missing region L, by alternatively ejecting the ink from the normal nozzles N on the left or right in the width direction of the malfunctioning nozzles.

The controller 40 sets allocation regions A for dot data corresponding to the malfunctioning nozzle from the detected first adhesion amount (step S155a). FIG. 7 is a diagram illustrating an example of a table indicating the correspondence relationship between the first adhesion amount and the patterns of the allocation regions A. The controller 40 sets the allocation regions A, for example, with reference to the table. In the example of FIG. 7, as the first adhesion amount increases, the number of allocation regions A decreases and the area of each allocation region A increases. More specifically, when the first adhesion amount increases, the length in the conveyance direction of each allocation region A increases. In the present embodiment, the controller 40 determines the allocation regions A to be 3 (in the width direction)×4 (in the conveyance direction)×2 (in number).

After the determination of the allocation regions A, the controller 40 allocates the dot data of the malfunctioning nozzle to the normal nozzles in the allocation regions A (step S156a). FIG. 8 illustrates an example of the first peripheral region R1 after the allocation to the allocation regions A. As a method of allocating the dot data of the malfunctioning nozzle, a known method may be appropriately adopted. For example, the dot data of the malfunctioning nozzle may be preferentially allocated in order of the non-ejection (0) and the small liquid droplet (1) among both sides in the width direction of the original dot generation position. Alternatively, dot data of the malfunctioning nozzle may be randomly allocated by allocating random numbers to the respective regions in the allocation regions A.

In the present embodiment, a series of processes from step S153a to step S156a is referred to as an allocation process. After completion of the allocation process of one malfunctioning nozzle, the controller 40 transitions to step S152a and checks again whether or not there is a malfunctioning nozzle for which the allocation process has not been completed.

### Effects of First Embodiment

As described above, the image forming apparatus 1 according to the present embodiment includes the image former 20 that causes the head units 24 each having the plurality of nozzles N arranged in a row to eject ink to generate dots. In addition, the image forming drum 21 functioning as a mover which relatively moves the recording medium M and the head units 24 in the conveyance direction is provided. The inkjet recording apparatus 1 further includes the controller 40 functioning as a detector that detects a first adhesion amount of ink in the first peripheral region R1 around the nozzle-missing region L and as an allocator that allocates dot data corresponding to the malfunctioning nozzle to the normal nozzles in the allocation regions A.

In particular, the controller 40 sets the allocation region A to be wide when the first adhesion amount is large and sets the allocation region A to be narrow when the first adhesion amount is small. More specifically, when the first adhesion amount is large, the length in the conveyance direction of the allocation region A is increased. In this way, by setting the allocation region A according to the first adhesion amount, a dot set to an malfunctioning nozzle is less likely to be formed at a position away from other dot formation positions, thus suppressing resulting deterioration in image quality. In addition, since the area of the allocation region A is set to be large when the first adhesion amount is large, it is possible to stably secure the alternative generation place in a case where a dot set to a malfunctioning nozzle is preferentially alternatively generated in a non-generation place of dot. In addition, since the length in the conveyance direction is increased when the area of the allocation region A is increased, the occurrence of white streaks can be further suppressed.

### [Missing Complementation Process] (Second Embodiment)

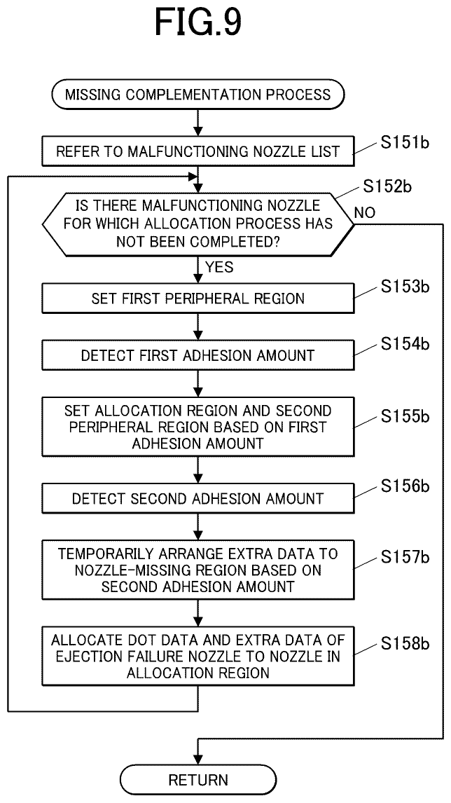

Next, a missing complementation process according to a second embodiment will be described with reference to FIG. 9 to FIG. 14. Note that contents substantially the same as those of the first embodiment are denoted by similar reference signs, and a detailed description thereof will be omitted.

FIG. 9 is a flowchart of the missing complementation process according to the second embodiment. Steps S151b to S154b are substantially the same as steps S151a to S154a, and thus a detailed description thereof will be omitted.

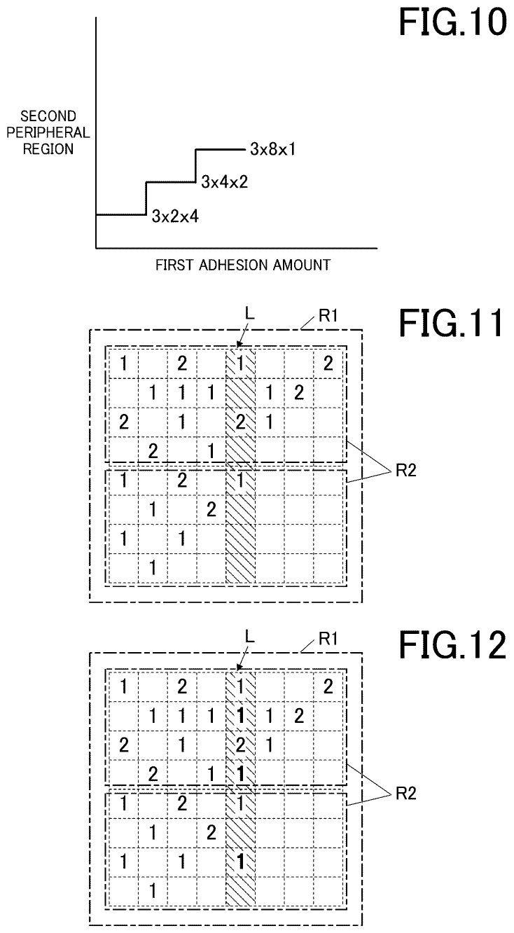

The controller 40 sets the allocation region A and the second peripheral regions R2 on the basis of the first adhesion amount detected in step S154b (step S155b). FIG. 10 is a diagram illustrating an example of a table indicating the correspondence relationship between the first adhesion amount and the second peripheral regions R2. Similar to the allocation regions A, the controller 40 sets the second peripheral regions R2, for example, with reference to the table.

FIG. 11 illustrates the second peripheral regions R2. As illustrated in FIG. 11, the second peripheral regions R2 are preferably set within the range of the first peripheral region R1.

The controller 40 detects a second adhesion amount which is a dot generation amount in the second peripheral regions R2 (step S156b). The method of detecting the second adhesion amount may be any appropriate method, as in the method of detecting the first adhesion amount.

The controller 40 determines an extra amount from the detected second adhesion amount by referring to the extra data reference table 423 and generates extra data. Next, as illustrated in FIG. 12, the controller 40 temporarily arranges the extra data in the nozzle-missing region L of the second peripheral regions R2 (step S157b).

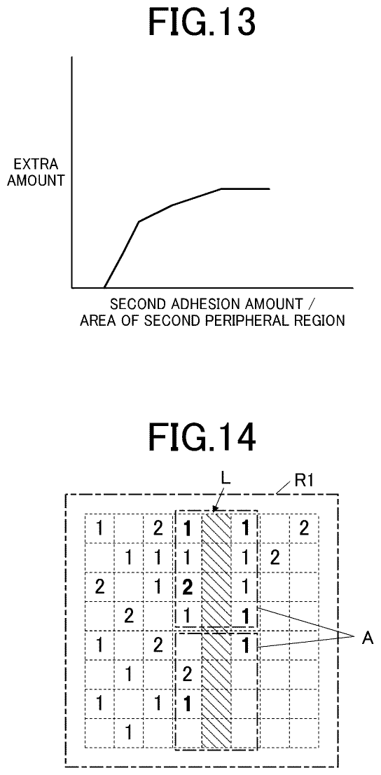

FIG. 13 is a diagram illustrating an example of the extra data reference table 423. In FIG. 13, the controller 40 determines the extra amount according to a value obtained by dividing the second adhesion amount by the area of the second peripheral region R2.

The controller 40 allocates the temporarily-arranged extra data and the dot data on the malfunctioning nozzle to the normal nozzles in the allocation regions A (step S158b). FIG. 14 illustrates an example of the first peripheral regions R1 after allocation to the allocation regions A. As a method of allocating the extra data, a known method may be appropriately adopted, similarly to the method of allocating the dot data of the malfunctioning nozzle. After completion of an allocation process of one malfunctioning nozzle, the controller 40 proceeds to step S152b as in the first embodiment.

### Effects of Second Embodiment

As described above, in the missing complementation process according to the second embodiment, the controller 40 sets the second peripheral regions R2 according to the first adhesion amount, and allocates the extra amount corresponding to the second adhesion amount to the normal nozzles in the allocation regions A. In general, the inkjet recording apparatus 1 forms a dot so that the diameter of one dot is larger than the theoretical diameter of one pixel in order to prevent the occurrence of white streaks. However, there is a case where it is not possible to suppress the occurrence of the white streaks due to the deviation amount between the nozzle rows, the variation in the dot diameters, or the like, only by moving the dot data of the malfunctioning nozzle to the nozzles N of the first peripheral region R1. Therefore, the inkjet recording apparatus 1 according to the present embodiment allocates, to the normal nozzles in the allocation regions A, a value obtained by dividing the adhesion amount in the second peripheral regions R2 by the number of pixels in the second peripheral regions R2, that is, an appropriate extra amount corresponding to the density. According to the configuration, it is possible to more reliably suppress the occurrence of white streaks.

### Modification Example

Although specific description has been given above on the basis of the embodiment according to the present invention, the present invention is not limited to the above-described embodiment. It is a matter of course that the present invention can be subjected to various modifications within the scope of the invention described in the claims and the equivalents thereof.

For example, although the halftone process is used to generate ejection data according to binary values or the number of steps of ink droplet size in the description above, it is not limited thereto. In addition, a well-known method such as a dither method may be used.

Furthermore, although the width direction that is the arrangement direction of the nozzles N and the conveyance direction of the recording medium M are described as being orthogonal to each other in the above embodiment, it is not limited thereto. Even if they intersect at an angle other than 90 degrees, an image can be formed in the same manner.

Furthermore, although an operation involving ink ejection by a malfunctioning nozzle may be cancelled upon allocation to a normal nozzle, the cancellation setting does not have to be performed if no ink is to be ejected.

Furthermore, although the inkjet recording apparatus 1 of a line head type in which a plurality of recording heads is arranged in the width direction has been described in the above-described embodiment, the present invention is not limited thereto. A single recording head may be provided. Furthermore, the image forming apparatus may be a serial head type image forming apparatus in which the head units 24 scan the recording medium M. Furthermore, the recording medium M does not need to be conveyed by the image forming drum 21. The recording medium M may be conveyed on a flat surface. Furthermore, although the image forming apparatus has been described as having inks of four colors of CMYK in the above embodiment, the colors of inks may be different from these, and the number of colors may be smaller or greater than these. In addition, inks of the same color having different components, such as two kinds of black inks, may be ejected.

In addition, in the above-described embodiment, the image forming apparatus has been described as the inkjet recording apparatus 1, but, as long as the image forming apparatus is an image forming apparatus in which a plurality of recording elements is arranged to form dots, the missing complementation process according to the contents described in the above-described embodiment can be applied.

Furthermore, although the controller 40 of the inkjet recording apparatus 1 performs the ejection data generating process including the missing complementation process in the description of the above embodiment, it is not limited thereto. That is, the external terminal device may perform the missing complementation process or the like, and the inkjet recording apparatus 1 may simply perform the image forming operation on the basis of the ejection data received from the external terminal device. Furthermore, the ejection data generation process may be executed in a distributed manner by a plurality of electronic devices or the like.

In the above description, the storage 42 including a nonvolatile memory such as a flash memory has been described as an example of a computer-readable medium that stores the program 421 according to the missing complementation process of the present invention, but the invention is not limited thereto. As other computer-readable media, it is possible to apply a hard disk drive (HDD), other nonvolatile memories such as an electrically erasable programmable read only memory (EEPROM) and a magnetic random access memory (MRAM), and a portable recording medium such as a CD-ROM and a DVD disk. As a medium for providing data of the program according to the present invention via a communication line, a carrier wave is also applied to the present invention.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus, comprising:
an image former that causes a head unit having a plurality of nozzles arranged in a row to eject a color material onto a recording medium conveyed in a conveyance direction to generate dots;
a mover that relatively moves the recording medium and the head unit in a direction intersecting an arrangement direction of the plurality of nozzles in the head unit; and
a hardware processor,
wherein the hardware processor
detects a first adhesion amount of a color material in a first peripheral region around a nozzle-missing region corresponding to a malfunctioning nozzle,
sets an allocation region having an area corresponding to the first adhesion amount, and
allocates dot data corresponding to the malfunctioning nozzle to a normal nozzle in the allocation region.

2. The image forming apparatus according to claim 1, wherein
the hardware processor
sets a second peripheral region according to the first adhesion amount,
detects a second adhesion amount of a color material in a second peripheral region,
generates extra data corresponding to the second adhesion amount, and
allocates the extra data to the normal nozzle in the allocation region.

3. The image forming apparatus according to claim 2, wherein the hardware processor sets the second peripheral region within the first peripheral region.

4. The image forming apparatus according to claim 3, wherein the hardware processor sets the second peripheral region such that a length in the conveyance direction of the second peripheral region is equal to or less than a length in the conveyance direction of the first peripheral region.

5. The image forming apparatus according to claim 1, wherein the hardware processor sets the area of the allocation region to be large in a case where the first adhesion amount is large.

6. The image forming apparatus according to claim 5, wherein the hardware processor sets a length in the conveyance direction of the allocation region according to the first adhesion amount.

7. A method of forming an image with an image forming apparatus that comprises an image former that causes a head unit having a plurality of nozzles arranged in a row to eject a color material onto a recording medium conveyed in a conveyance direction to generate dots, and
a mover that relatively moves the recording medium and the head unit in a direction intersecting an arrangement direction of the plurality of nozzles in the head unit, the method comprising:
detecting a first adhesion amount of a color material in a first peripheral region around a nozzle-missing region corresponding to a malfunctioning nozzle;
region setting an allocation region having an area corresponding to the first adhesion amount; and
allocating dot data corresponding to the malfunctioning nozzle to a normal nozzle in the allocation region.

8. A non-transitory computer readable storage medium storing a program causing a computer of an image forming apparatus that comprises: an image former that causes a head unit having a plurality of nozzles arranged in a row to eject a color material onto a recording medium conveyed in a conveyance direction to generate dots; and
a mover that relatively moves the recording medium and the head unit in a direction intersecting an arrangement direction of the plurality of nozzles in the head unit, to perform:
detecting a first adhesion amount of a color material in a first peripheral region around a nozzle-missing region corresponding to a malfunctioning nozzle;
setting an allocation region having an area corresponding to the first adhesion amount; and
allocating dot data corresponding to a malfunctioning nozzle to a normal nozzle in the allocation region.
